(19) United States
(12) Patent Application Publication
(10) Pub. No.: US 2006/0184253 A1
(43) Pub. Date: Aug. 17, 2006

(54) Intelligent method of organizing and presenting operational mode information on an instrument panel of a flight deck

(75) Inventors: James Neal Andrews, Austin, TX (US); David Bruce Kumhyr, Austin, TX (US); Richard J. Smith, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/050,604

(22) Filed: Feb. 3, 2005

(51) Int. Cl. G05B 11/01; G08G 1/16; G05B 15/00; G08B 3/00; G08B 21/00

(52) U.S. Cl. 700/17; 340/903; 340/945; 340/691.6; 700/83

(57) ABSTRACT

The present invention provides a method, computer program product and system for organizing and displaying operational mode information on an instrument panel of a flight deck. A display controller receives input from various sources, including, but not limited to, the pilot/co-pilot, instruments and controls on the aircraft and externally from control towers. The display controller analyzes this data to determine an appropriate operational mode of the aircraft. Once this determination is made, the display controller configures spatial representation and placement of output to the display device, in accordance with the determined operational mode. The display device can be reconfigured to display information for all instruments at one central location.

### BACKGROUND OF THE INVENTION

1. Technical Field

The present invention relates generally to a method, apparatus and computer program product for presentation of flight information on a cockpit instrument panel. In particular, the present invention is directed to varying data displayed on a cockpit instrument panel according to the operational mode of an aircraft.

2. Description of Related Art

Modern commercial/private aircraft employ a large number of instrumentation panels having controls and displays used to present information related to aircraft sensors. The controls and the displays are operated, viewed, and interpreted by a pilot/co-pilot during flight of an aircraft. More and more of these functions are being delivered to the pilot/co-pilot via, LCD (liquid crystal display), LED (light emitting diode) or OLED (organic light emitting diode) displays. Some of these controls are used for assisting the pilot/co-pilot with navigation, such as an altimeter, an airspeed indicator, angle of attack indicator, a horizontal situation indicator, an attitude indicator, and the like. Other controls are used to permit radio communication with other pilots/co-pilots in the air or with air traffic controllers during flight. Still more controls, in recent years, are used to assist in navigation using Global Positioning Satellite (GPS) systems associated with satellite technology. Furthermore, transponder controls permit the aircraft to be uniquely identified and the aircraft's altitude communicated to air traffic controllers during flight.

The sheer quantity of controls and display panels contained within the cockpit of an aircraft is daunting. Pilots/co-pilots must stay focused and alert in order to access various controls within the cockpit and interpret information presented on various displays throughout the cockpit. As a result, pilots/co-pilots must continually scan a plurality of available displays for vital flight information at any particular moment in time during flight. With so many flashing electronic displays competing for the pilot's/co-pilot's attention, input overload has become a real concern.

In recent years, multifunction displays (MFDs) have been developed, such that a single display screen presents control data associated with controls within the cockpit. However, MFDs are limited to presenting data related to only a few select controls within the cockpit.

Furthermore, the Federal Aviation Association has promulgated regulations requiring that some sensors have backup sensors and have backup presentation on multiple displays within the cockpit in the event a primary control or display, presenting any setting data associated with the controls, should fail during flight. Backup is especially important for communication sensors and navigational sensors, since these sensors vitally assist a pilot during flight. Generally, these sensors are set as radio frequencies, although in recent years GPS sensors provide additional navigational information. Furthermore, one or more channels are generally required for both communication and navigation within the aircraft during flight. These channels are recognized by those skilled in the art as acronyms COM1, COM2, NAV1, and NAV2. A variety of controls within the cockpit are associated with COM and NAV communication sensors. Therefore multiple displays still exist within the cockpit. Correspondingly, the pilot/co-pilot must still manage a myriad of displays and controls located at various locations throughout the cockpit.

As a result, the pilot/co-pilot is often forced to view multiple display screens to obtain all the relevant setting data associated with the controls. As different instruments and displays show information that is vital for differential operational modes of the aircraft, the pilot/co-pilot constantly has to locate different displays depending on the operational mode of the aircraft in order to get the vital information. Further, the pilot/co-pilot is forced to manually switch to alternate displays and controls in the event of a sensor or a display failure. Moreover, the plethora of controls and displays often occupy a large amount of physical space within the cockpit of an aircraft, and physical space within the cockpit is often a precious commodity.

As is apparent to those skilled in the art, a pilot/co-pilot must remain alert and focused on controls and displays at important points during the flight, such as takeoffs, landings, inclement weather, emergencies, or equipment malfunctions. Thus, pilots/co-pilots are required to have many hours of training to master the controls and displays within the cockpit before receiving the proper certification to fly an aircraft. This is especially true with larger commercial aircraft. Moreover as a result of the heightened mental acuity required during flight, many federal regulations also restrict the amount of time a pilot/co-pilot is permitted to fly in any given day in order to ensure the pilot/co-pilot remains alert during flight.

Therefore, there exists a need for a better control and presentation of sensor data within the cockpit, which permits the pilot/co-pilot to more rapidly acquire vital information and to manage the controls related to that information.

### SUMMARY OF THE INVENTION

The present invention provides a method, computer program product and system for organizing and displaying operational mode information on a flight deck. A display controller receives input from various sources, including, but not limited to, the pilot/co-pilot, instruments and controls on the aircraft and externally from control towers. The display controller analyzes this data to determine an appropriate operational mode of the aircraft. Once this determination is made, the display controller configures the spatial representation and placement of the output to the display device, in accordance with the determined operational mode. The display device can be reconfigured to display information for all instruments at one central location.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a data processing system in which the present invention may be implemented in accordance with a preferred embodiment of the present invention.

FIG. 2 is a block diagram of a system in which the present invention may be implemented according to a preferred embodiment of the present invention.

FIG. 3a is a pictorial representation of a flight deck of an aircraft having an instrument panel in accordance with the prior art.

FIG. 3b is a pictorial representation of a flight deck of an aircraft having a display device in accordance with a preferred embodiment of the present invention.

FIG. 4a is a pictorial representation of a display device in accordance with a preferred embodiment of the present invention.

FIG. 4b is a pictorial representation of a display device in accordance with a preferred embodiment of the present invention.

FIG. 4c is a pictorial representation of a display device in accordance with a preferred embodiment of the present invention.

FIG. 5 is a flowchart that illustrates a method for configuring a display device in accordance with a preferred embodiment of the invention.

FIG. 6 is a flowchart that illustrates a method for configuring a display device in accordance with a preferred embodiment of the invention.

### DETAILED DESCRIPTION OF THE PREFERRED EMBODIMENT

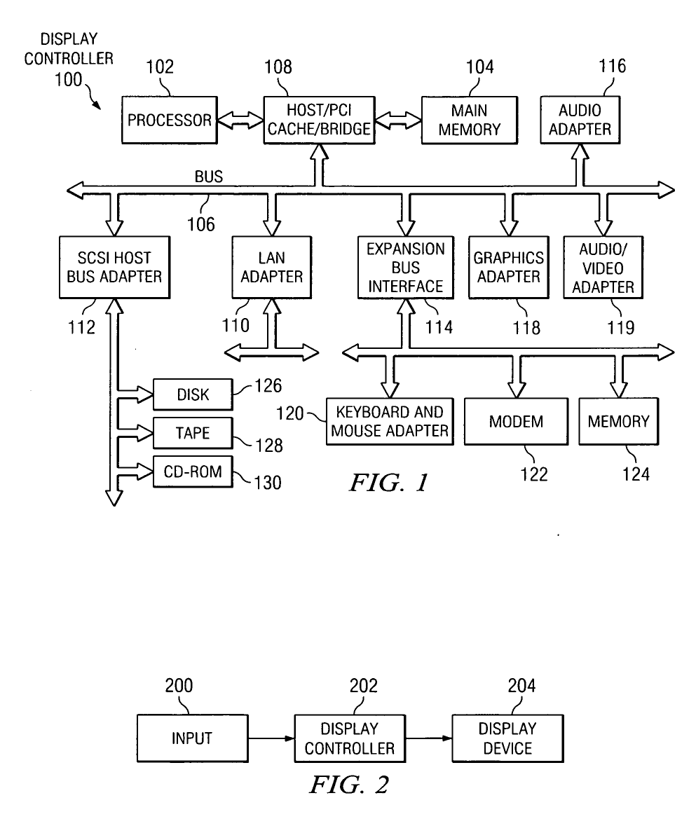

With reference now to the figures and in particular with reference to FIG. 1, a data processing system in which the present invention may be implemented in accordance with a preferred embodiment of the present invention. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in connectors. In the depicted example, local area network (LAN) adapter 110, small computer system interface (SCSI) host bus adapter 111, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 110, modem 111, and additional memory 114. SCSI host bus adapter 111 provides a connection for hard disk drive 116, tape drive 118, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system such as Windows XP, which is available from Microsoft Corporation. An object oriented programming system such as Java may run in conjunction with the operating system and provides calls to the operating system from Java programs or applications executing on data processing system 100. “Java” is a trademark of Sun Microsystems, Inc. Instructions for the operating system, the object-oriented programming system, and applications or programs are located on storage devices, such as hard disk drive 116, and may be loaded into main memory 104 for execution by processor 102.

Those of ordinary skill in the art will appreciate that the hardware in FIG. 1 may vary depending on the implementation. Other internal hardware or peripheral devices, such as flash read-only memory (ROM), equivalent nonvolatile memory, or optical disk drives and the like, may be used in addition to or in place of the hardware depicted in FIG. 1. Also, the processes of the present invention may be applied to a multiprocessor data processing system.

The depicted example in FIG. 1 and above-described examples are not meant to imply architectural limitations.

FIG. 2 is a block diagram of a system in which the present invention may be implemented according to a preferred embodiment of the present invention. Display controller 202 can be implemented as a data processing system, such as data processing system 100 in FIG. 1, in which code or instructions implementing the processes of the present invention may be located. Input 200 is received by display controller 202. Input 200 can come from a variety of sources, including, but not limited to, manually, from the pilot or co-pilot, automatically from the aircraft's controls and instruments and externally from control towers or other broadcast beacon signals.

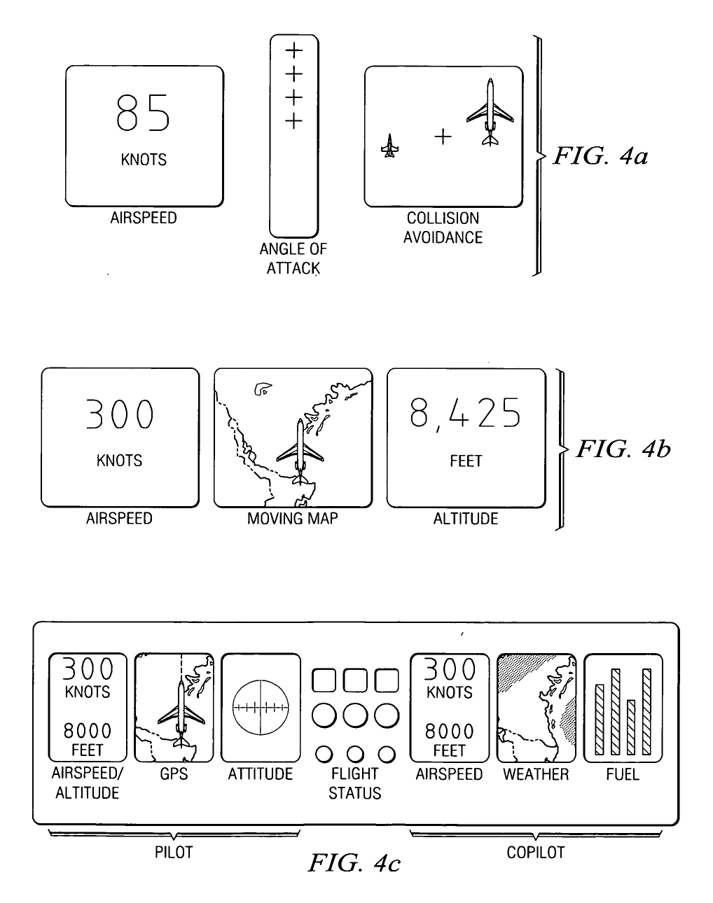

Once display controller 202 determines the appropriate operational mode, display controller 202 configures the spatial representation and placement of the output to display device 204 in accordance with the determined operational mode. FIGS. 4a, 4b and 4c illustrate examples of how display device 204 might be configured to show operational mode information. Some possible operational modes include, but are not limited to, take off, landing, emergency, off, parked and cruising. Also, display controller 202 can configure display device 204 to display operational mode information for multiple users, such as both the pilot and co-pilot, simultaneously.

In one embodiment, display controller 202 determines the operational mode of the aircraft and automatically reconfigures display device 204 in accordance with this determination and then the pilot or co-pilot has the ability to override the choice. A variation of this setup would be that after the display controller changes the display configuration, the pilot or co-pilot has to confirm the configuration or it will revert back to the previous mode. Alternatively, the display controller could be configured so that when the flight mode of the aircraft has been determined, the controller then indicates to the pilot or co-pilot that it would like to switch the display to a configuration based on the determined operational mode. The pilot or co-pilot can then approve this change. A combination of these configurations could have the display controller automatically switch display configurations under specific conditions, such as when it determines that an emergency is occurring.

Display device 204 can be reconfigured to display information for all instruments at one central location. In contrast, the current art is that the information is displayed at many different locations all over the flight deck, requiring the pilot to look at several displays in order to get all the information that he needs.

In a preferred embodiment, display device 204 is made up of an OLED material. OLED material has several advantages over current LED and LCD displays. OLED material does not require backlighting, as LEDs and LCDs do. Therefore, an OLED display requires less energy to power. Additionally, OLED has a much higher contrast ratio. Currently, many OLEDs have a contrast ratio of 1000:1 or more, some reaching as high as 5000:1, while most LEDs have a contrast ratio of about 500:1. Therefore images will appear much clearer and sharper on an OLED display.

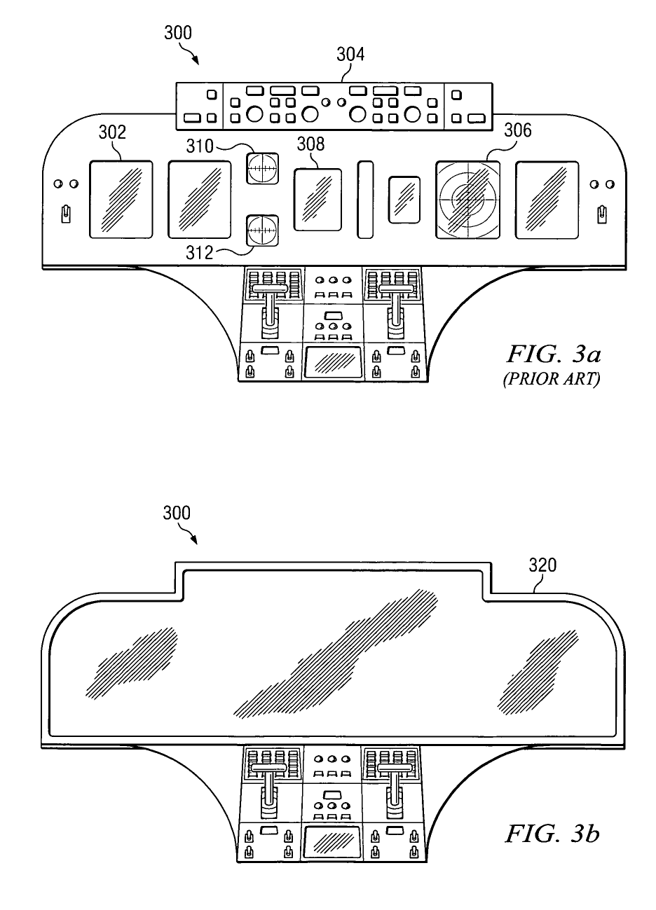

FIG. 3a is a pictorial representation of a flight deck of an aircraft having an instrument panel in accordance with the prior art. Flight deck 300 shows an instrument panel with a conventional configuration of instrument displays, such as primary flight display 302, navigational controls 304, radar display 306, system information display 308, altitude indicator 310 and direction finder 312. Other instruments and displays occur on an instrument panel and the configuration can vary. FIG. 3a is just one example of a possible implementation of the prior art.

FIG. 3b is a pictorial representation of a flight deck of an aircraft having a display device in accordance with a preferred embodiment of the present invention. Flight deck 300 shows display device 320 in a preferred location. However, display device 320 could be located in various places throughout the flight deck. For instance, display device 320 could be added to an existing flight deck as a standalone piece of equipment. Also, there could be multiple occurrences of display device 320 in the flight deck as there could be additional units for the co-pilot and redundancy back-up units. Display device 320 has no set configuration and can be figured to display instrument output in many different configurations, depending on the operational mode. FIGS. 4a, 4b and 4c illustrate how some of the configurations might appear on display device 320.

FIG. 4a is a pictorial representation of a display device in accordance with a preferred embodiment of the present invention. FIG. 4a shows a display device, like display device 204 in FIG. 2, as it might appear when configured for take off.

FIG. 4b is a pictorial representation of a display device in accordance with a preferred embodiment of the present invention. FIG. 4b shows a display device, like display device 204 in FIG. 2, as it might appear when configured for cruising mode.

FIG. 4c is a pictorial representation of a display device in accordance with a preferred embodiment of the present invention. FIG. 4c shows a display device, like display device 204 in FIG. 2, as it might appear when configured to show information for two users, such as both the pilot and co-pilot, in cruising mode.

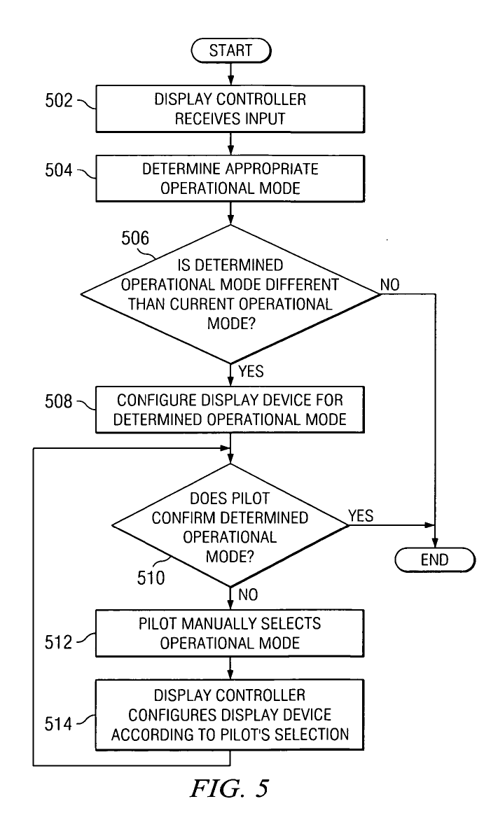

FIG. 5 is a flowchart that illustrates a method for configuring a display device in accordance with a preferred embodiment of the invention. The method begins when a display controller receives input (step 502). Input can be from a variety of sources, such as navigational instruments, pilot input or information from a control tower. The display controller then analyses the input to determine an appropriate operational mode (step 504). The display controller then compares the determined operational mode to the current operational mode to see if they are different (step 506). If no change in operational mode is indicated (a no output to step 506), the method ends. If a change in operational mode is indicated (a yes output to step 506), the display controller configures the display device for the determined operational mode (step 508). The display controller then asks the pilot to confirm the determined operational mode (step 510). If the pilot confirms the determined operational mode (a yes output to step 510), the method ends. If the pilot does not confirm the determined operational mode (a no output to step 510), the pilot is prompted to manually indicate the correct operational mode (step 512). The display controller then configures the display device in accordance with the operational mode determined by the pilot's selection (step 514). The display controller then asks the pilot to confirm the determined operational mode (step 510).

For example, when the power in an aircraft is turned on, the dip lay controller would receive that input and determine that appropriate operational would be parked. As this is different than the off mode the display controller had been in, it would see that the mode is different and change the configuration of output to the display device. In this example the configuration would be changed from a blank screen, in the off operational mode, to the information important at aircraft start up in the parked operational mode.

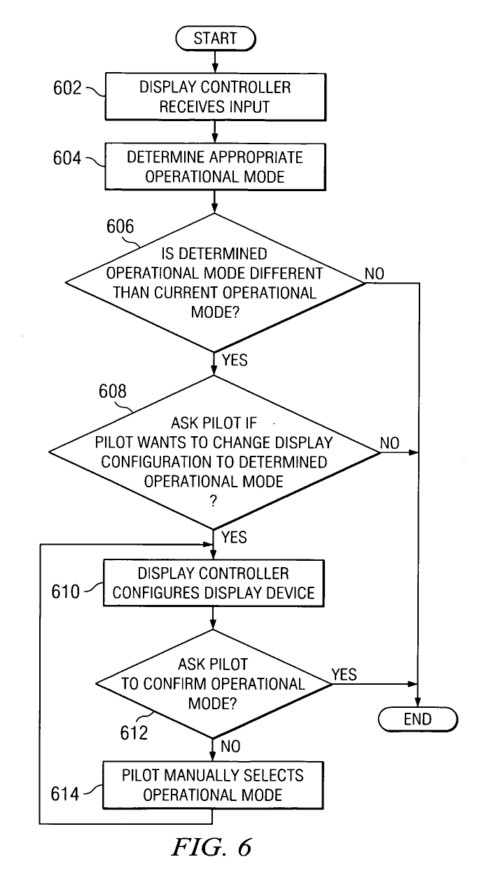

FIG. 6 is a flowchart that illustrates a method for configuring a display device in accordance with a preferred embodiment of the invention. The method begins when a display controller receives input (step 602). Input can be from a variety of sources, such as navigational instruments, pilot input or information from a control tower. The display controller then analyses the input to determine an appropriate operational mode (step 604). The display device then compares the determined operational mode to the current operational mode to see if they are different (step 606). If no change in operational mode is indicated (a no output to step 606), the method ends. If a change in operational mode is indicated (a yes output to step 606), the display controller asks the pilot if the pilot wants to change the display configuration to the determined operational mode (step 608). If the pilot chooses not to change the display device to the determined operational mode (no output of step 608), the method ends. If the pilot agrees to change the configuration of the display device in accordance with the determined operational mode (yes output of step 608), the display controller configures the display device in accordance with the new operational mode (step 610). The display controller then asks the pilot to confirm the determined operational mode (step 612). If the pilot confirms the determined operational mode (a yes output to step 612), the method ends. If the pilot does not confirm the determined operational mode (a no output to step 612), the pilot is prompted to manually indicate the correct operational mode (step 614). The display controller then configures the display device in accordance with the operational mode determined by the pilot's selection (step 610).

Thus, the present invention solves disadvantages of the prior art by providing better control and presentation of sensor data within the cockpit of an aircraft, which permits the pilot/co-pilot to more rapidly acquire vital information and to manage the controls related to that information. The present invention provides a method, computer program product and system for organizing and displaying operational mode information on an instrument panel on a flight deck. A display controller receives input from various sources, including, but not limited to, the pilot/co-pilot, instruments and controls on the aircraft and externally from control towers. The display controller analyzes this data to determine an appropriate operational mode for the aircraft. Once this determination is made, the display controller configures the display device to display information in accordance with the determined operational mode. The display device can be reconfigured to display information for all instruments at one central location.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for organizing and presenting operational mode information on an instrument panel on a flight deck, the method comprising:
receiving input;
determining an appropriate operational mode based on the input; and
configuring spatial representation and placement of output to a display device in accordance with the determined operational mode.

2. The method of claim 1, further comprising:
requesting a user to confirm a change of the display device in accordance with the determined operational mode.

3. The method of claim 2, further comprising:
responsive to the user not confirming the change of the display device in accordance with the determined operational mode, prompting the user to select an operational mode.

4. The method of claim 1, wherein the input comprises at least one of information from the user, information from instruments and controls and information from control towers or other external sources.

5. The method of claim 1, wherein the determined operational mode comprises at least one of parked, emergency, takeoff, cruising, off and landing.

6. The method of claim 1, wherein the spatial representation and placement of output to a display device is configured for two different users.

7. A computer program product in a computer readable medium for organizing and presenting operational mode information on an instrument panel on a flight deck, comprising:
first instructions for receiving input;
second instructions for determining an appropriate operational mode based on the input; and
third instructions for configuring spatial representation and placement of output to a display device in accordance with the determined operational mode.

8. The computer program product of claim 7, further comprising:
fourth instructions for requesting a user to confirm a change of the display device in accordance with the determined operational mode.

9. The computer program product of claim 8, further comprising:
fifth instructions, responsive to the user not confirming the change of the display device in accordance with the determined operational mode, for prompting the user to select an operational mode.

10. The computer program product of claim 7, wherein the input comprises at least one of information from the user, information from instruments and controls and information from control towers or other external sources.

11. The computer program product of claim 7, wherein the determined operational mode comprises at least one of parked, emergency, takeoff, cruising, off and landing.

12. The computer program product of claim 7, wherein the spatial representation and placement of output to a display device is configured for two different users.

13. A system for organizing and presenting operational mode information on an instrument panel on a flight deck, the system comprising:
receiving mechanism for receiving input;
determining mechanism for determining an appropriate operational mode based on the input; and
configuring mechanism for configuring spatial representation and placement of output to a display device in accordance with the determined operational mode.

14. The system of claim 13, further comprising:
requesting mechanism for requesting a user to confirm a change of the display device in accordance with the determined operational mode.

15. The system of claim 14, further comprising:
prompting mechanism, responsive to the user not confirming the change of the display device in accordance with the determined operational mode, for prompting the user to select an operational mode.

16. The system of claim 13, wherein the input comprises at least one of information from the user, information from instruments and controls and information from control towers or other external sources.

17. The system of claim 13, wherein the determined operational mode comprises at least one of parked, emergency, takeoff, cruising, off and landing.

18. The system of claim 13, wherein the configuring mechanism configures the spatial representation and placement of output to a display device for two different users.

19. The system of claim 13, further comprising:
displaying mechanism for displaying output, wherein the displaying mechanism is capable of being reconfigured to display information for all instruments at one central location.

20. The method of claim 1, further comprising:
comparing the determined operational mode to a current operational mode to see if they are different.
